(19) United States
(12) Patent Application Publication
(10) Pub. No.: US 2004/0220887 A1
(43) Pub. Date: Nov. 4, 2004

(54) Making purchase decisions

(76) Inventors: Andrew Robert Byde, Cardiff (GB); Christopher William Preist, Bristol (GB); Claudio Bartolini, Menlo Park, CA (US); Michal Morciniec, Bristol (GB)

Correspondence Address: HEWLETT-PACKARD COMPANY, Intellectual Property Administration, P.O. Box 272400, Fort Collins, CO, 80527-2400, US

(21) Appl. No.: 10/698,850

(22) Filed: Oct. 31, 2003

(30) Foreign Application Priority Data
Oct. 31, 2002 (GB) 0225400.1

(51) Int. Cl. G06F 17/60

(52) U.S. Cl. 705/400; 705/1

(57) ABSTRACT

Apparatus and method for use in making a purchase decision regarding purchase of a plurality of units of a good or service from a plurality of potential suppliers (14) at one or more purchasing times, the apparatus being arranged to determine, estimate or otherwise obtain one or more outcomes for each purchasing time based on one or more quantities of units (16) of the good or service potentially or actually required to be purchased at the purchasing time and/or predicted fluctuations of price of said good or service during said purchase period and access details (10) of terms under which said good or service may be purchased from each of the potential suppliers (14). The apparatus is arranged to determine an optimal purchase strategy regarding purchase of the good or service during the purchase period, which optimal purchase strategy is defined in terms of, for each outcome at the or each purchasing time, an allocation among the plurality of potential suppliers (14) of a quantity (16) actually or expected to be required to be purchased so as to minimise a total predicted cost of purchasing the good or service during the purchase period.

### FIELD OF THE INVENTION

This invention relates generally to the purchase of goods and services and, more particularly, to a method and apparatus for use in making a purchase decision regarding purchase of a plurality of units of a good or service from a plurality of different potential suppliers.

### BACKGROUND TO THE INVENTION

It is common practice for commercial organisations to distribute their purchasing requirements for one or more goods and services among a number of approved suppliers. There are a number of advantages to the adoption of this strategy, including the ability to monitor and even control the market price per unit of the goods and services in question. Further, this provides the organisation with the ability to purchase any required number of units of a good or service at short notice at the best available price.

Generally, in such cases, long-term “framework” contracts may be negotiated and effected between the purchasing organisation and each approved supplier, which contracts often do not specify a particular quantity of a good or service to be purchased during the contract period, but instead specify discounts which will apply if the quantity of the good or service purchased exceeds some predetermined level. Cost penalties may additionally or alternatively be specified in the event that the quantity of the good or service purchased during the contract period falls below some pre-arranged minimum. Thus, contracts are often established with multiple suppliers, each having different terms and conditions, but potentially concerning the same type of good or service.

Each time a purchaser wishes to purchase a quantity of the good or service in question, there are a number of issues which may need to be considered in order to make the purchase in the most cost-effective manner. Of course, one of these issues will be the cost of the current order, based on the current price and required quantity (including any discounts which may be applicable at that time), and the calculation of the price of a particular order by multiplying the total number of units by the respective price per unit and applying any relevant discounts is relatively simple. However, another issue to be considered may be the avoidance of penalties (which may not be applied until the end of the contract period). In other words, each time a purchaser has a short-term need for a good or service, it is desirable to determine how to distribute the current purchase among the suppliers in such a way as to avoid penalties and accrue discounts, while at the same time buying the goods or services as cheaply as possible on the day. As such, the question of how to distribute each purchase among the suppliers is highly non-trivial, involving elements of risk management with respect to future purchase volume and potential price fluctuations, because in the event that an incorrect purchase strategy is adopted, significant unnecessary costs can be incurred.

It will be appreciated that, if discounts or penalties may be incurred by buying many or too few goods respectively, then it may be worthwhile, at a particular purchasing time, to buy the goods at a slightly higher price early on, in order to ensure that penalty charges are not incurred later, for example. However, the question of how high a price to accept will, of course, depend on the value of the discounts and penalties and, therefore, how much money one might save, as well as fluctuations in future price and/or demand (bearing in mind that price variations will affect the monetary value of any discounts).

### SUMMARY OF THE INVENTION

In accordance with the present invention, there is provided apparatus for use in making a purchase decision regarding purchase of a plurality of units of a good or service from a plurality of potential suppliers at a plurality of purchasing times within a purchase period, the apparatus comprising means for determining, estimating or otherwise obtaining one or more outcomes for each of said purchasing times outcome being defined in terms of a quantity of units of said good or service potentially or actually required to be purchased at a respective purchasing time and/or a predicted price of said good or service at a respective purchasing time, means for accessing details of terms under which said good or service may be purchased from each of said potential suppliers during said purchase period, and means for determining an optimal purchase strategy regarding purchase of said good or service during said purchase period, said optimal purchase strategy being defined in terms of, for each outcome, an allocation among said plurality of potential suppliers of a quantity of said good or service actually or expected to be required to be purchased in the event of said outcome, so as to minimise a total predicted cost of purchasing said good or service during said purchase period.

Also in accordance with the present invention, there is provided a method for use in making a purchase decision regarding purchase of a plurality of units of a good or service from a plurality of potential suppliers at a plurality of purchasing times within a purchase period, the method comprising the steps of determining, estimating or otherwise obtaining one or more outcomes for each of said purchasing times each outcome being defined in terms of a quantity of units of said good or service potentially or actually required to be purchased at a respective purchasing time and/or a predicted price of said good or service at a respective purchasing time, accessing details of terms under which said good or service may be purchased from each of said potential suppliers during said purchase period, and determining an optimal purchase strategy regarding purchase of said good or service during said purchase period said optimal purchase strategy being defined in terms of, for each outcome, an allocation among said plurality of potential suppliers of a quantity of said good or service actually or expected to be required to be purchased in the event of said outcome, so as to minimise a total predicted cost of purchasing said good or service during said purchase period.

Thus, the apparatus and method of the present invention take a description of likely future purchasing requirements and/or likely future price variations for each potential supplier, and provide an optimal purchase strategy (at least in respect of the current purchasing time and/or one or more future purchasing times within a purchase period) based on each of a number of future eventualities. By optimising the expected return from a given contract, the apparatus and method of the present invention have the potential to save large amounts of money in purchasing.

The terms under which the particular good or service may be purchased from each of the potential suppliers during the above-mentioned predetermined period (hereinafter referred to as “the contract period”) will preferably include any discount offered if a quantity of units of the good or service purchased exceeds a predetermined level, and/or any penalty which may be incurred if a quantity of units of the good or service purchased during the contract period is less than some pre-arranged minimum.

A total quantity of units of said good or service expected to be required to be purchased at the one or more purchasing times within the purchase period is preferably estimated by means of a probability function, possibly based on one or more quantities of the good or service purchased at respective previous purchasing times. Similarly, any likely future price variations may be estimated by means of a probability function, possibly based on one or more prices or price variations at respective previous purchasing times.

The apparatus and method are preferably arranged to calculate a minimum expected cost of future purchasing of the good or service, which expected cost of future purchasing of the good or service is preferably calculated by calculating the expected cost of purchasing at the one or more purchasing times within the purchase period (which may themselves be estimated on the basis of previous purchasing behaviour, or they may be pre-set).

The minimum expected purchasing cost is preferably calculated taking into account discounts offered by one or more suppliers for single orders of the good or service consisting of a quantity of units greater than a predetermined level, discounts offered by one or more of the suppliers for cumulative orders of the good or service greater than a predetermined level, and penalties applied by one or more of the suppliers in the event that the quantity of the good or service purchased during the contract period is less than some pre-set minimum.

### BRIEF DESCRIPTION OF THE DRAWINGS

An embodiment of the invention will now be described by way of example only and with reference to the accompanying drawings, in which:

FIG. 1 is a schematic diagram illustrating the principal elements of a method and apparatus according to an exemplary embodiment of the present invention;

FIG. 2 is a schematic diagram illustrating the manner in which future “outcomes” are derived;

FIG. 3 is a flow diagram illustrating a method according to an exemplary embodiment of the present invention.

### DETAILED DESCRIPTION OF AN EMBODIMENT OF THE INVENTION

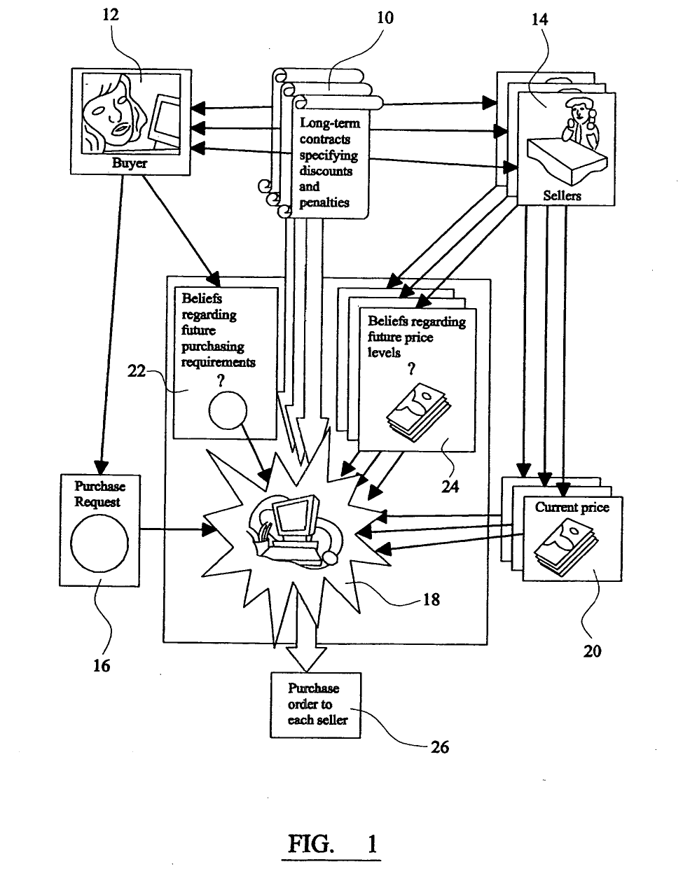

Referring to FIG. 1 of the drawings, long-term “framework” contracts 10 exist between a buyer 12 and several approved suppliers 14. The contracts 10 tend not to specify the quantities of a good or service being purchased over the contract periods, but instead tend to specify general terms, such as discounts which may apply if the quantity purchased exceeds a predetermined level, and penalties which may apply if the quantity purchased falls short of some pre-arranged minimum level.

The buyer 12, at a current purchasing time t, inputs a quantity of a good or service to be purchased in the form of one or more purchase requests or orders 16 to the apparatus 18. The apparatus obtains or receives information relating to the current price 20 at which each of the approved suppliers 14 are selling the good or service (excluding discounts and penalties). The apparatus 18 also receives or accesses details of the contracts 10 which exist between the buyer 12 and the suppliers 14 (including any discounts and/or penalties specified therein).

An algorithm is employed which builds an estimate of the expected cost of future purchasing of the good or service, based on likely future purchasing requirements and (optionally) likely future price variations. Thus, a probability function is applied to purchasing requirements at previous purchasing times, to determine likely future purchasing requirements 22 and a similar probability function is applied to previous prices and price variations for each supplier 14, so as to determine likely future price variations 24. Using the details of the contracts 10, and the likely future purchasing requirements 22 and price variations 24, the apparatus 18 calculates an estimated cost of future purchasing at time T (the last purchasing time within a contract period) and then optimises for all purchase allocations over the entire purchasing period at the same time to produce a strategy of purchase allocations to be selected at each purchasing time within the purchasing period, conditional upon possible outcomes at each purchasing time, so as to minimise expected total purchasing cost within the purchasing period. Purchase order(s) 26 may be generated automatically according to the strategy.

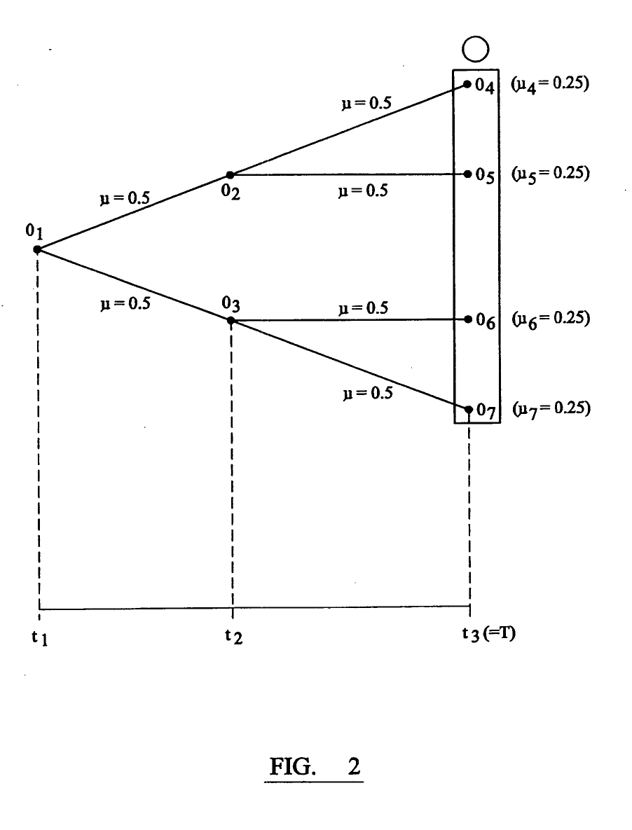

Referring now to FIG. 2 of the drawings, consider a contract period T having three purchasing times t₁ (current purchasing time), t₂, and t₃ (final purchasing time in the contract period) defined therein.

At the final purchasing time t₃ (=T), there are a number of potential outcomes o₄, o_{5, o}₆, o₇ (say), defined collectively as the vector O. Each outcome may be defined in terms of a price/demand combination at time t₃ and has a probability value μ associated with it. It will be appreciated that each outcome at t₃ is dependent on the outcome at t2. Thus, in the specific example, o₁ (the outcome or price/demand at the current purchasing time t₁) is known. Given o₁, the outcome at t₂ may be o₂ (for example, demand and price remains the same as for o₁) or o₃ (demand increases, price remains the same, say), with the probability of each being 0.5. Given o₂ the outcome at t₃ may be o4 or o5 and given o3, the outcome at t₃ may be o₆ or o7, with the probability of each being 0.25 (for example).

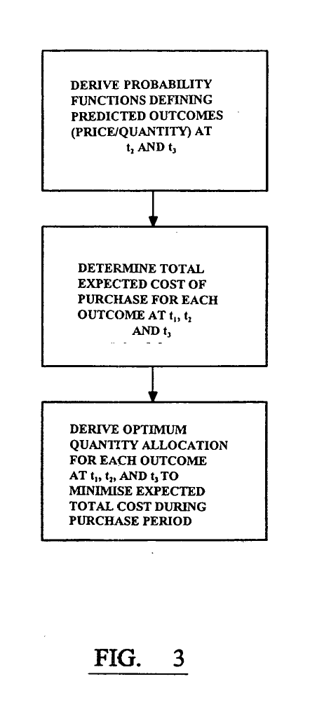

Thus, the total expected cost at t₁, t₂, t₃ may be derived and optimised at the same time by optimising quantity allocations using any known non-linear optimisation tool (such as that provided in software packages such as “Matlab” or “Mathematica”) to produce a strategy of purchase allocations which can be selected at each purchasing time, conditional upon various possible outcomes at each time, so as to minimise expected total purchasing cost. This is described in more detail below. This simplified summary of the method according to an exemplary embodiment of the present invention is illustrated in FIG. 3 of the drawings, the output being a choice of q₁, q₂, q₃, q₄, q₅, q₆ and q₇ (for each respective outcome o₁, . . . , o₇) to minimise the expected total purchasing cost during the purchase period T.

It will be appreciated that the problem can be simplified (and speed and efficiency of the method and apparatus of the invention could be improved) by making assumptions, by limiting how far into the future it is required to predict, or recalculating the optimum purchase decision at each purchasing time

An exemplary method according to the invention will now be described in more detail.

Assumptions and Notation

We consider sellers S={s₁, . . . , s_{N}} and buyers B={b₁, . . . , b_{M}} of some good, where sellers are not differentiated on quality.

At fixed purchase times t=1, . . . , T demand of individual buyers is aggregated and distributed among the sellers.

Bold indicates vectors of values for each seller/buyer: The quantities demanded by the buyers will be written as d=(d^{b}^{¹}, . . . , d^{bM}), the quantity supplied by the seller sεS to buyer bεB will be written q^{sb}, and vector notation used here as well: q=(q^{s}^{¹}^{b}^{¹}, . . . , q^{sNbM}).

The cost of shipping goods from a seller to a buyer is not necessarily the same for all buyer-seller pairs: we model shipping costs as constant per unit, σ^{sb} for sεS, bεB.

The collection of buyers holds a master contract for each seller, specifying the following clauses:

Start and End times: Goods may only be purchased from a seller in a certain window in order to qualify for the discounts. We treat this by saying that to each purchasing time t there is a collection Sₜ⊂s of sellers whose contracts are valid at that time.

Discounts: Each contract specifies a discount function δ (q)ε[0,1], defining the proportion by which the quoted price p^{s} is reduced, as a function of the total number of units so far purchased. It is assumed that discount functions are to be positive increasing functions with δ(0)=0.

$$δ ( q ) = \{ \begin{matrix}0 if q < 100 \\ 0.2 if q \geq 100\end{matrix} \qquad ( 1 )$$

specifies that the first 100 units purchased will cost $1 each, with each additional unit cost 80 c each.

Risk neutral.

Formal Solution

In this section, a mathematical specification of the optimization problem to be solved is formulated in order to determine the values for q^{sb} at each purchasing time minimizing the expected total cost of purchasing over the entire contract period.

Probability

Let O be the (finite) set of possible joint outcomes of all random events during the purchasing process, and let μ:O→R⁺ be a probability function on O, i.e μ(o)≧0 for all outcomes o, and Σ_{oεO}μ (o)=1.

for each t there is an equivalence relation μₜ on O defined by μₜ (o, o|) if and only if o and Lo| agree on all random events occurring before time t. This gives rise to equivalence classes Oₜ and we write πₜ for the map which takes an outcome o to its equivalence class under μₜ. Since the elements of Oₜ correspond to the outcomes of events before time t, these are also referred to herein as outcomes, even though later events are not determined.

Example Consider flipping a coin twice, just before times 1 and 2. The set of all possible outcomes can be modelled as {(H,H), (H,T), (T,H), (T,T)} where H stands for “heads” and T for “tails”. At time 1 the coin will have been flipped only once, so O₁ has two equivalence classes, labelled H and T. O₂=O, since by time 2 all random events have occurred. Each of the outcomes in O has equal probability μ₍ₒ₎=0.25.

General Problem

In general, variables are labelled with outcomes for any random events on which they might depend. This gives demand and price vectors at time t written as dₒₜ and Pₒₜ respectively, for oₜ Oₜ. Since the demand and price vectors depend on the outcome in Oₜ so will the quantity allocation, the quantity allocation vector q is therefore labelled with oₜ as well. For oₜOₜ, define

$${H}_{Ot}^{s} ( q ) = {\sum }_{t - 1}^{t} {\sum }_{b ∈ B} {q}_{n {t}_{( ot )}}^{sb}$$

This is the total amount of goods that will be bought from seller s up to and including time step t, if outcome oₜ occurs. The shipping cost of the purchase allocation qₒₜ at time t is

$${\sum }_{b ∈ B , s ∈ S} {q}_{{o}_{t}}^{sb} {σ}^{sb}$$

and so the total immediate cost of the goods bought at time t is

$${ICost}_{ot} ( q ) = {\sum }_{s ∈ S} {p}_{ot}^{s} {\sum }_{q = {H}_{π - 1 {( ot )}^{q}}^{s}}^{{H}_{ot}^{s} ( q ) - 1} ( 1 - δ ( q ) ) + {\sum }_{s ∈ S , b ∈ B} {q}_{ot}^{sb} {σ}^{sb} \qquad ( 2 )$$

The total cost of goods over the full purchasing period, with a given final outcome, is

$${Cost}_{o} ( q ) = {\sum }_{t = 1}^{T} {ICost}_{{π}_{t ( o )}} ( q ) , \qquad ( 3 )$$

with the expected value of this cost being

$$E ( Cost ) ( q ) = {\sum }_{o ∈ O} μ ( o ) {Cost}_{O} ( q ) \qquad ( 4 )$$

In general, the problem of purchasing allocation is to find a choice of q_{Ot}^{sb} for every combination sεS, bεB, tε{1, . . . , T} and oₜεOₜ minimising E(Cost) subject to at least the following constraints.

q_{Ot}^{sb}≧0, (5)

q_{Ot}^{sb}=0, if s∉S_{t,} (6)

$${\sum }_{s ∈ S} {q}_{Ot}^{sb} = {d}_{Ot}^{b} \qquad ( 7 )$$

The first of these constraints requires goods to flow only from sellers to buyers; the second requires the purchaser not to send orders out on contracts that are not operational; the third insists that the total quantity sold to a given buyer is the same as the amount that seller is demanding.

It is possible to impose additional constraints, such as an upper bound on the total amount purchased from a given seller at each time step; to be general, it may be assumed that there is a set Q(d) of possible quantity allocations such that qεQ(d) only if (5), (6) and (7) hold. In terms of this set, the allocation chosen should be

arg max _{qεQ(d)} E(Cost)(q) (8)

Contracts with Fixed Prices

If prices are fixed in the contracts, at p^{s} say, and if the only constraints on possible allocations, in addition to (5), (6) and (7) are linear (in-)equalities, then the problem becomes much simpler. In this case, since the constraints defining the set of possible quantity allocations are all linear, Q (d) must be a polygon. The cost function becomes simpler:

$${Cost}_{o} ( q ) = {\sum }_{s ∈ S} {p}^{s} {\sum }_{q = o}^{{h}_{oq ) - 1}^{s}} ( 1 - {δ}^{s} ( {q}^{\vert} ) ) + {\sum }_{t = 1}^{T} {\sum }_{s ∈ S , b ∈ B} {q}_{{π}_{t} ( o )}^{sb} {σ}^{sb} \qquad ( 9 )$$

More importantly, Costₒₜ is now concave with respect to q when extended in a natural way to real numbers, because its rate of change with respect to each q_{Ot}^{sb} variable is

σ^{sb}+(1−δ^{s}(H_{Ot}^{s}(q)))

which is non-increasing; E(Cost) must be concave also, since it is a non-negative linear combination of concave functions.

Convacity and Polygons

Definition 1^{A set Sε}R ^{m} is a polygon if

S is closed, bounded, and non-empty, and

There are finitely many non-zero linear functions l₁, l₂, . . . , lₖ: R^{m}→R and real numbers c₁, c₂, . . . , cₖ so that

xεSZ,1 lᵢ(X)≦cᵢ∀ᵢ=1, . . . , k

Notice that k must be greater than or equal to m+1 for such a set to be bounded. The corners of a polygon S are the points xεS such that there are at least m of the linear functions lᵢ₁, . . . , lᵢₘ vanishing simultaneously at x, with no two functions sharing a null-space: ∀(a,b)ε{1, . . . , m} either a=b or ∃y: l_{ib} (y)≠0, l_{ib} (y)=0.

Definition 2 A concave^{function f :Ω}⊂R^{m}→R is one for which

f(tx+(1−t)y)≧f(x)+(1−t)f(y) for all x, y^{εΩ}

It is a standard mathematical result that a concave function on a closed and bounded domain Ω in R^{m} achieves its minimum on the boundary of Ω. It is also simple to show that the boundary of a polygon is a union of polygons. It follows that a concave function on a polygon must achieve its minimum at one of the corners of that polygon.

From this it follows that the values of q from (8) must be corners of Q(d), i.e. for every t=1, . . . , T outcome oₜ, and bεB, the entire demand is allocated to one seller, s, so that q_{Ot}^{sb}=d_{Ot}^{b}, and q_{Ot}^{s′b}=0 for all other sellers s″ (which allocation may depend on the outcomes of random events.

This restriction makes solution much easier, since there are only finitely many such allocations; an exhaustive search will give the lowest expected price.

Example Consider the following setup:

One buyer;

Two sellers, fixed prices, p=(1,1.1); the first seller gives no discount, the second gives a 30% discount on all units after the first two.

n=2, demand at time 1 equal to 1, demand at time 2 either 3 or 1 with probabilities μ=0.2, 1−μ=0.8, respectively.

The set of outcomes is O=O₂={hi,lo}, corresponding to the two possible outcomes for demand at time 2. O₁={*} is just a singleton. This gives 6 variables: q*¹, q*², *qₕᵢ², qₗₒ¹ and qₗₒ². The constraint (7) implies that q*²=1−q*¹, qₕᵢ²=3−qₕᵢ¹ and qₗₒ²=1−qₗₒ¹, so there are only three independent variables.

Since each must take an external value, there are precisely 8 possibilities. However, the price of buying 3 units from s₂ is at most 1.1×(2+0.7)=2.97, so if hi occurs, then irrespective of which purchases have been made at time step 1 it must be preferable to buy from s₂, i.e. qₕᵢ²=3 at the optimum point. Likewise, if lo occurs, then the single unit should be bought from s₁ irrespective of decisions at time 1, qₗₒ¹=1. This leaves just two choices, depending on whether q*¹ takes value 1 or 0. If q*¹=1 then the expected payment is

1+μ×1.1×(2+0.7)+1−μ)×1=2.394

If q*¹=0 then the expected payment is

1.1+μ633 1.1×(1+2×0.7)+(1−μ)×1=2.428

The lowest expected cost is achieved by buying from seller s₁ at time 1, then from either s₂ or s₁ at time 2 depending on whether hi or lo occurs, respectively. If the probability μ were higher, for example, 0.5,—then it would become preferable to buy the first unit from seller s₂ instead, but the entire purchase order is always given to a single seller in each time step.

Fixed-price Contracts with Spot Market

We can introduce a spot market as a seller mεS with indeterminate prices and no discounts. Since the market offers no bulk discounts, its cost function is particularly simple.

$${Cost}_{Ot}^{m} ( q ) = {p}_{Ot}^{m} {\sum }_{b ∈ B} {q}_{Ot}^{mb} + {\sum }_{b ∈ B} {q}_{Ot}^{mb} {σ}^{mb} \qquad ( 10 )$$

which is linear, and hence concave with respect to the variables q_{Ot}^{mb}. It follows that the same result as before can be applied, and the minima of the expected cost in this case must once again be at the corner points.

An example is given below of a case where non-fixed prices with discount lead to non-corner solutions.

Proof that Non-corner Solutions Exist

Proof by example:

Example Consider the following setup, which has the same outcome structure as the previous example.

One buyer.

Two sellers, the first with fixed price of 1, the second with a price 1.0125 at time 1, and price either 0.5 or 2 at time 2, with equal likelihood μ=0.5.

Both sellers give the same discount: 10% discount on every unit purchased beyond the fifth δ^{s} (q)=0.1 for q≧5,0 or otherwise).

Demand at time 1 equal to 10, demand at time 2 equal to 5.

As before the independent variables are q*, qₗₒ and qₕᵢ. It is not hard to see that irrespective of the choice of q* the optimal allocation at time 2 is qₜₒ=0, qₕᵢ=5: if the price of seller s₂ is as low as 0.5 at time 2 then all 5 units should be bought from s₂ irrespective of history; likewise a price as high as 2 makes purchasing from s₁ inevitable.

Taking these values for qₗₒ and qₕᵢ to be implicit, the expected cost can be written as a function of q*:

$$\begin{matrix}E ( Cost ) ( q *) = {q}_{*} + 1.0125 \times ( 10 - {q}_{*} ) + \\ μ \times 0.5 \times {\sum }_{10 - {q}_{*}}^{14 - {q}_{*}} ( 1 - δ ( q ) ⅆ q + \\ ( 1 - μ ) \times {\sum }_{{q}_{*}}^{{q}_{*} + 4} ( 1 - δ ( q ) ) ⅆ q\end{matrix} \qquad ( 13 )$$

This can be simplified to

$$E ( Cost ) ( {q}^{*} ) = \{ \begin{matrix}13.875 - 0.062 {q}_{*} & 0 \leq {q}_{*} \leq 5 \\ 13.625 + 0.0125 {q}_{*} & 5 \leq {q}_{*} \leq 10\end{matrix} \qquad ( 14 )$$

It follows that choosing q*=5 is expected to be strictly cheaper than either extreme.

Other Market Mechanisms

Any other market mechanism, such as auction or 1-1 negotiation can be introduced at a single time step quite simply so long as there is no master contract binding future potential discounts. This is done by producing a reservation price, the price below which an alternative to the existing contract structure becomes favourable. For a single alternative, we see that the maximum price that should be paid for a given quantity is the difference between the expected cost from the existing contracts including this quantity, and the expected cost from the existing contracts excluding this quantity.

To be precise, suppose that we consider an allocation of quantities q^{b} at time t=1 to buyers b, and that a price p is offered for these goods, including shipping to the buyers. This deal is worth taking if and only if

$$ρ \leq {min}_{q ∈ Q ( d )} E ( Cost ) ( q ) - {min}_{q ∈ Q ( d - q )} E ( Cost ) ( q ) \qquad ( 11 )$$

where the modified set of possible quantity vectors Q(d-q) is given by the same constraints as Q(d) with the exception that the demand constraint at time 1 is now

$${\sum }_{s ∈ S} {q}_{{*}_{1}}^{s b} = {d}_{{*}_{1}}^{b} - {q}^{b} \qquad ( 12 )$$

This formula can be used to generate a reservation price for a fixed-quantity opportunity such as an auction, or could be applied to several “test” allocations to derive an approximate understanding of how the reservation price changes with respect to q. For an English auction, the reservation price will simply be an upper limit to bidding. For 1-1 negotiations more is needed, although a description of appropriate negotiation mechanisms is beyond the scope of this specification. Any mechanism that uses a maximal willingness to pay as an input is appropriate.

If there are many spot alternatives to the master contracts, then a similar formula to (12) can be used to evaluate each individually against those sellers for which contracts are held. The allocation q can be understood as aggregating across collections of alternatives, to give the value of diverting certain quantities to a collection of alternative markets. Once again, mechanisms for negotiating in such circumstances, and for evaluating objective value criteria in such heterogeneous environments is beyond the scope of this document, but any such technique taking as input the maximal willingness to pay for any collection of purchasing opportunities is appropriate.

Approximation Techniques

The main optimization (8) is much simpler if prices are fixed, or non-fixed prices unaccompanied by discounts, but the corresponding search over corners may still be intractable. In general (8) is the optimization of a non-linear function over a polygonal region, and as such there exist several different approaches to finding a solution, each better adapted to a different class of underlying problems. Here we discuss a handful of approaches which may or may not prove efficient in finding approximate solutions.

Analysis and Approximation. If the form of δ is sufficiently simple then the function E(Cost) becomes correspondingly simple; it may be possible to find a minimizing allocation using mathematical analysis directly, or via a computer algebra system such as Mathematica. If the discounts are approximable by simple function, the expected cost and hence optimal decision for the simpler problem is likely to be a good solution for the un-approximated problem.

Corner Search for General Case. Although for a combination of uncertain prices and discounts it is not necessary for a solution to be at a corner of Q (d), it is not unreasonable to suppose that these values may in many cases be close to minimal. A search over the set of corners can thus give a good approximate minimizer in some cases, and a good starting point for other optimization techniques in general.

Iterative Local Optimization. In this method a test point q is maintained and incrementally changed by optimizing the allocation choice at a given partial outcome: the values of qₒₜ for a fixed time and outcome are optimized, keeping all other allocations fixed, and then the time and outcome shifted to new values. A systematic way to do this would be to fix a time step, and optimize the allocation for each partial outcome at this time before moving on to the next time. The time variable could be moved from one extreme to the other, applying local optimization at each outcome on the way.

This local optimization is over a small dimensional polygon, and can be done either analytically, if the form of δ is sufficiently simple, or using some standard operations analysis tool such as those provided in well known software packages, such as “Matlab” or “Mathematica”.

This technique can be applied to the simplified corners-only problem by locally optimizing the choice of corner.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than restrictive, sense.

1. Apparatus for use in making a purchase decision regarding purchase of a plurality of units of a good or service from a plurality of potential suppliers at a plurality of purchasing times within a purchase period, the apparatus comprising means for determining, estimating or otherwise obtaining one or more outcomes for each of said purchasing times outcome being defined in terms of a quantity of units of said good or service potentially or actually required to be purchased at a respective purchasing time and/or a predicted price of said good or service at a respective purchasing time means for accessing details of terms under which said good or service may be purchased from each of said potential suppliers during said purchase period, and means for determining an optimal purchase strategy regarding purchase of said good or service during said purchase period, said optimal purchase strategy being defined in terms of, for each outcome, an allocation among said plurality of potential suppliers of a quantity of said good or service actually or expected to be required to be purchased in the event of said outcome, so as to minimise a total predicted cost of purchasing said good or service during said purchase period.

2. Apparatus according to claim 1, wherein said terms under which said good or service may be purchased from each of the potential suppliers during said purchase period include any discount offered if a quantity of units of the good or service purchase exceeds a predetermined level.

3. Apparatus according to claim 1, wherein said terms include any penalty which may be incurred if a quantity of units of the good or service purchased during said purchase period is less than a preset minimum.

4. Apparatus according to claim 1, wherein a total quantity of units of said good or service expected to be required to be purchased at one or more purchasing times within said purchase period is estimated by means of a probability function.

5. Apparatus according to claim 4, wherein said probability function is based on one or more quantities of the good or service purchased at respective previous purchasing times.

6. Apparatus according to claim 1, wherein said predicted price fluctuations are estimated by means of a probability function.

7. Apparatus according to claim 6, wherein said probability function is based on one or more prices or price variations at respective previous purchasing times.

8. Apparatus according to claim 1, arranged to calculate a minimum expected cost of future purchasing of the good or service within said purchase period.

9. Apparatus according to claim 8, wherein said expected cost of future purchasing of the good or service is calculated by calculating the expected cost of purchasing in respect of each outcome relating to the or each purchasing time within said period.

10. Apparatus according to claim 8, wherein said minimum expected purchasing cost is calculated taking into account discounts offered by one or more suppliers for single orders of the good or service consisting of a quantity of units greater than a predetermined level, discounts offered by one or more of the suppliers for cumulative orders of the good or service greater than a predetermined level, and penalties applied by one or more of the suppliers in the event that the quantity of the good or service purchased during the contract period is less than a pre-set minimum.

11. Apparatus according to claim 8, wherein said minimum expected purchasing cost is calculated taking into account shipping costs in respect of each potential supplier.

12. Apparatus according to claim 11, wherein said shipping costs are modelled as a constant per unit of said good or service.

13. (cancelled)

14. A method for use in making a purchase decision regarding purchase of a plurality of units of a good or service from a plurality of potential suppliers at a plurality of purchasing times within a purchase period, the method comprising the steps of determining, estimating or otherwise obtaining one or more outcomes for each of said purchasing times each outcome being defined in terms of a quantity of units of said good or service potentially or actually required to be purchased at a respective purchasing time and/or a predicted price of said good or service at a respective purchasing time, accessing details of terms under which said good or service may be purchased from each of said potential suppliers during said purchase period, and determining an optimal purchase strategy regarding purchase of said good or service during said purchase period said optimal purchase strategy being defined in terms of, for each outcome, an allocation among said plurality of potential suppliers of a quantity of said good or service actually or expected to be required to be purchased in the event of said outcome, so as to minimise a total predicted cost of purchasing said good or service during said purchase period.

15. A method according to claim 14, wherein said terms under which said good or service may be purchased from each of the potential suppliers during said purchase period include any discount offered if a quantity of units of the good or service purchase exceeds a predetermined level.

16. A method according to claim 14, wherein said terms include any penalty which may be incurred if a quantity of units of the good or service purchased during said purchase period is less than a preset minimum.

17. A method according to claim 14, wherein a total quantity of units of said good or service expected to be required to be purchased at said one or more future purchasing times within said purchase period is estimated by means of a probability function.

18. A method according to claim 17, wherein said probability function is based on one or more quantities of the good or service purchased at respective previous purchasing times.

19. A method according to claim 14, wherein said predicted price fluctuations are estimated by means of a probability function.

20. A method according to claim 19, wherein said probability function is based on one or more prices or price variations at respective previous purchasing times.

21. A method according to claim 14, including the step of calculating a minimum expected cost of future purchasing of the good or service within said purchase period.

22. A method according to claim 21, wherein said expected cost of future purchasing of the good or service is calculated by calculating the expected cost of purchasing in respect of each outcome relating to the or each purchasing time within said purchase period.

23. A method according to claim 21, wherein said minimum expected purchasing cost is calculated taking into account discounts offered by one or more suppliers for single orders of the good or service consisting of a quantity of units greater than a predetermined level, discounts offered by one or more of the suppliers for cumulative orders of the good or service greater than a predetermined level, and penalties applied by one or more of the suppliers in the event that the quantity of the good or service purchased during said purchase period is less than a pre-set minimum.

24. A method according to claim 21, wherein said minimum expected purchasing cost is calculated taking into account shipping costs in respect of each potential supplier.

25. A method according to claim 24, wherein said shipping costs are modelled as a constant per unit of said good or service.

26. (cancelled)

27. Apparatus for use in making a current purchase decision regarding purchase of a plurality of units of a good or service from a plurality of potential suppliers based on a plurality of projected purchasing times within a purchase period, the apparatus comprising means for determining, estimating or otherwise obtaining one or more outcomes for each of said projected purchasing times, each outcome being defined in terms of a quantity of units of said good or service projected as being required to be purchased at a respective projected purchasing time and/or a predicted price of said good or service at a respective projected purchasing time, means for accessing details of terms under which said good or service may be purchased from each of said potential suppliers during said purchase period, and means for determining a said current purchase decision, said current purchase decision being defined in terms of, for each outcome, an allocation among said plurality of potential suppliers of a quantity of said good or service to be currently purchased in the event of said outcome, so as to minimise a total predicted cost of purchasing said good or service during said purchase period.
